(19) United States
(12) Patent Application Publication
(10) Pub. No.: US 2009/0059152 A1
(43) Pub. Date: Mar. 5, 2009

(54) LIQUID CRYSTAL DISPLAY

(75) Inventors: Tsuyoshi Kamada, Kanagawa (JP); Yoji Nagase, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/204,552

(22) Filed: Sep. 4, 2008

(30) Foreign Application Priority Data
Sep. 5, 2007 (JP) 2007-229847

(51) Int. Cl. G02F 1/1343

(52) U.S. Cl. 349/144

(57) ABSTRACT

A liquid crystal display capable of narrowing a slit between pixel electrodes and preventing a short circuit defect is provided. The liquid crystal display includes a plurality of pixels arranged in a matrix form, in which each of the pixels includes: a plurality of non-linear elements formed on a substrate; a plurality of subpixel electrodes electrically connected to the plurality of non-linear elements, respectively; and an inter-subpixel insulating layer formed between at least two subpixel electrode out of the plurality of subpixel electrodes.

### CROSS REFERENCES TO RELATED APPLICATIONS

The present invention contains subject matter related to Japanese Patent Application JP 2007-229847 filed in the Japanese Patent Office on Sep. 5, 2007, the entire contents of which being incorporated herein by reference.

### BACKGROUND OF THE INVENTION

1. Field of the Invention

The present invention relates to a liquid crystal display specifically suitable for VA (Vertical Alignment) mode.

2. Description of the Related Art

In recent years, VA mode liquid crystal displays used in liquid crystal televisions and the like have utilized a novel technique called multi-pixel to improve viewing angle characteristics in gray levels. As shown in FIG. 10, each pixel is divided into a plurality of subpixels A and B, and the subpixel A increases its intensity according to an input gray level, and then the subpixel B increases its intensity later. To obtain superior viewing angle characteristics, it is desired to reduce the area of the subpixel A so that the area ratio of the subpixels A and B becomes approximately 1:2 rather than 1:1.

FIGS. 11A and 11B show configurations of pixel electrodes and a common electrode of the subpixels A and B, and FIG. 11C shows an equivalent circuit of them. There are some methods of having a potential difference between the subpixels A and B; however, in FIGS. 11A to 11C, for example, the case where dedicated thin film transistors TFT1 and TFT2 are arranged in the subpixels A and B, respectively, and two source bus lines SL1 and SL2 are arranged with respect to the same gate bus line GL to drive the thin film transistors TFT1 and TFT2 is shown.

The multi-pixel includes the thin film transistors TFT1 and TFT2, a liquid crystal device Clc1 constituting the subpxiel A, a liquid crystal device Clc2 constituting the subpixel B, and capacitors Cst1 and Cst2. The gates of the thin film transistors TFT1 and TFT2 are connected to the gate bus line GL. The source of the thin film transistor TFT1 is connected to the source bus line SL1, and the drain of the thin film transistor TFT1 is connected to an end of the liquid crystal device Clc1 and an end of the capacitor Cst1. The source of the thin film transistor TFT2 is connected to the source bus line SL2, and the drain of the thin film transistor TFT2 is connected to an end of the liquid crystal device Clc2 and an end of the capacitor Cst2. The other end of the capacitor Cst1 and the other end of the capacitor Cst2 are connected to a capacitor bus line CL.

The pixel electrode Px1 for the subpixel A is connected to the thin film transistor TFT1, and the pixel electrode Px2 for the subpixel B is connected to the thin film transistor TFT2. As shown in an equivalent circuit diagram in FIG. 11C, the pixel electrode Px1 for the subpixel A and the pixel electrode Px2 for the subpixel B are electrically independent of each other, and a control circuit determines what kind of voltage is written to the pixel electrodes Px1 and Px2.

In the pixel electrodes Px1 and Px2, slits 112 for inclining liquid crystal molecules in a 45° direction are arranged as a configuration specific to VA mode. Some of the slits 112 are common slits for separating the pixel electrodes Px1 and Px2 from each other. On the other hand, a slit 122 for liquid crystal molecular alignment control is necessary for the common electrode 121 arranged on a facing substrate. As a liquid crystal molecular alignment control means on the facing substrate side, in some cases, an insulating projection (not shown) is formed on the common electrode 121. In FIG. 11A, the slit 122 of the common electrode 121 is shown by broken lines.

FIGS. 12A, 12B, 13A and 13B are illustrations for describing the width of the slit 112. A cell thickness d of the liquid crystal display, that is, a space between a TFT substrate 110 and a facing substrate 120 is typically approximately 4 μm. In the case where the width of the slit 112 is sufficiently wide with respect to the cell thickness d, as shown in FIG. 12A, the equipotential surface of the slit 112 enters deep into glass of the TFT substrate 110, and in the slit 112, an electric field in a vertical direction becomes weaker. Therefore, as shown in FIG. 12B, while the vertical alignment of the liquid crystal molecules 131 in the slit 112 is maintained, an electric field in an oblique direction is sufficiently generated on the pixel electrodes Px1 and Px2 in proximity to the slit 112, and the alignment direction of liquid crystal molecules becomes stable.

In the slit 112, the liquid crystal molecules 131 are not inclined, and do not contribute to transmittance, so when the width of the slit 112 is increased, a substantial aperture ratio declines, thereby the transmittance declines. On the other hand, when the width of the slit 112 is reduced, the aperture ratio is increased, but as shown in FIG. 13A, an electric field in proximity to the slit 112 gradually becomes less oblique, and as shown in FIG. 13B, the alignment stability of the liquid crystal molecules 131 is deteriorated. When the direction angles of the liquid crystal molecules 131 are shifted from 45°, the effect of the liquid crystal molecules 131 on polarization is changed, so transmittance per unit area is reduced, and even if the aperture ratio is increased, overall transmittance declines.

In other words, as shown in FIG. 14, the width of the slit 112 with respect to transmittance has an optimum value, and the optimum width of the slit 112 with respect to the cell thickness d of 4 μm is typically designed to be approximately 10 μm.

FIG. 15 shows the alignment of the liquid crystal molecules 131 in the slit 112 in the case where a voltage having a reverse polarity is applied to two pixel electrodes Px1 and Px2. In this case, in great contrast to FIGS. 12A and 13A, the equipotential surface vertically enters into the slit 112 between the pixel electrodes Px1 and Px2. Moreover, in the slit 112, a place having the same potential as that of the common electrode 121 is typically formed. In the place having the same potential, the liquid crystal molecules 131 are not inclined and are aligned in a vertical direction, and the liquid crystal molecules 131 become extremely stable. On the other hand, an oblique electric field is strong, so as a result, the alignment of the liquid crystal molecules 131 becomes extremely stable. In addition, the smaller the width of the slit 112 is, the more the effect is enhanced.

FIGS. 16A and 16B show illustrations in the case where in consideration of the effect, assuming that a voltage having a reverse polarity is applied to two pixel electrodes Px1 and Px2 in the multi-pixel shown in FIGS. 11A to 11C, slits 112A between the pixel electrodes Px1 and Px2 are narrowed. Slits 112B in the lower left corner and the upper left corner and the slit 122 of the common electrode 121 of the facing substrate 120 are not slits between the electrodes Px1 and Px2, so they are designed as before.

FIG. 17 shows transmittance in the case where the width of the slit 112A is reduced as in the case shown in FIGS. 16A and 16B. It is clear from FIG. 17 that in the case where a voltage having the same polarity is applied to two pixel electrodes Px1 and Px2 (same polarity driving), when the width of the slit 112 is 10 μm or less, the transmittance declines due to deterioration in the liquid crystal molecular alignment; however, in the case where a voltage having a reverse polarity is applied to two pixel electrodes Px1 and Px2 (reverse polarity driving), when the slit 112A is narrowed, the transmittance is able to be improved (for example, refer to Japanese Unexamined Patent Application Publication No. 2005-316211).

### SUMMARY OF THE INVENTION

However, as shown in FIGS. 16A and 16B, when the width of the slit 112A is reduced, there is an issue that the rate of increase in short circuit defects between the pixel electrodes Px1 and Px2 is pronouncedly increased. The length of the slit 112A is very long, so only a tiny amount of dust in a screen in manufacturing steps causes a defect.

In the configuration of a pixel in a related art which is not a multipixel, a slit is included only to control the liquid crystal molecular alignment, and a voltage having the same polarity is applied to all pixel electrodes, so even if a short circuit occurs, the short circuit does not cause an electrical defect, and the liquid crystal molecular alignment has a macroscopically minimal defect, so a failure does not occur.

Moreover, in the case of a multipixel which is not reverse polarity driven, a voltage having the same polarity is applied to the pixel electrodes Px1 and Px2. Therefore, when a short circuit occurs, voltages of the pixel electrodes Px1 and Px2 are not normal, but alienation of the voltages from a normal voltage is small, and gamma is slightly off. For example, in the case of full illumination of 255/255, a voltage having a positive polarity or a negative polarity of approximately 7 V is applied to the pixel electrodes Px1 and Px2, and it is difficult to distinguish an abnormal pixel from normal pixels.

However, in the case of reverse polarity driving, as shown in an equivalent circuit diagram in FIG. 18B, a potential difference between subpixels is increased, so as shown in FIG. 18A, when a planar short circuit S occurs between the pixel electrodes Px1 and Px2, a large leakage current flows. For example, in the case of full illumination of 255/255, when +7 V is applied to the pixel electrode Px1, −7 V is applied to the pixel electrode Px2, and when −7 V is applied to the pixel electrode Px1, +7 V is applied to the pixel electrode Px2, and the voltage is leaked between the pixel electrodes Px1 and Px2, so the voltage hardly remains in pixels, so the pixels become dark spots where a voltage is not applied constantly. As described above, in the case of reverse polarity driving, in consideration of yields, there is a limit to reducing the width of the slit 112A.

In view of the foregoing, it is desirable to provide a liquid crystal display capable of narrowing a slit between pixel electrodes and preventing a short circuit defect.

According to an embodiment of the invention, there is provided a liquid crystal display including a plurality of pixels arranged in a matrix form, in which each of the pixels includes: a plurality of non-linear elements formed on a substrate; a plurality of subpixel electrodes electrically connected to the plurality of non-linear elements, respectively; and an inter-subpixel insulating layer formed between at least two subpixel electrode out of the plurality of subpixel electrodes.

In the liquid crystal display according to the embodiment of the invention, the inter-subpixel insulating layer is arranged between at least two subpixel electrodes out of the plurality of subpixel electrodes, so even in the case where a planar defect is present between the two subpixel electrodes, the occurrence of a short circuit is prevented. Therefore, the two subpixel electrodes are able to be placed close to the limit. Therefore, a slit between the two subpixel electrodes is narrowed, and the transmittance is improved by the stability of the liquid crystal molecular alignment.

In the liquid crystal display according to the embodiment of the invention, the inter-subpixel insulating layer is arranged between at least two subpixel electrodes out of the plurality of subpixel electrodes, so a slit between the two subpixel electrodes is able to be narrowed, and a short circuit defect is able to be prevented. Therefore, an advantage of narrowing a slit which is that the liquid crystal molecular alignment is stabilized to improve the transmission is able to be maximized.

Other and further objects, features and advantages of the invention will appear more fully from the following description.

### BRIEF DESCRIPTION OF THE DRAWINGS

FIG. 1 is an illustration showing the whole configuration of a liquid crystal display including a liquid crystal display panel according to a first embodiment of the invention;

FIG. 2 is an equivalent circuit diagram of a pixel of the liquid crystal display panel shown in FIG. 1;

FIG. 3 is a sectional view showing a configuration of a part of the liquid crystal display panel shown in FIG. 1;

FIG. 4 is a sectional view showing a connection configuration of a subpixel electrode and a TFT shown in FIG. 3;

FIG. 5 is a sectional view showing a configuration of a part of a liquid crystal display panel according to a second embodiment of the invention;

FIGS. 6A and 6B are a plan view and an equivalent circuit diagram of a pixel shown in FIG. 5;

FIG. 7 is a sectional view showing a configuration of a part of a liquid crystal display panel according to a third embodiment of the invention;

FIG. 8 is a sectional view showing a configuration of a part of a liquid crystal display panel according to a fourth embodiment of the invention;

FIG. 9 is a sectional view showing a configuration of a part of a liquid crystal display panel according to a fifth embodiment of the invention;

FIG. 10 is an illustration showing an example of displaying gray levels by a multipixel in a related art;

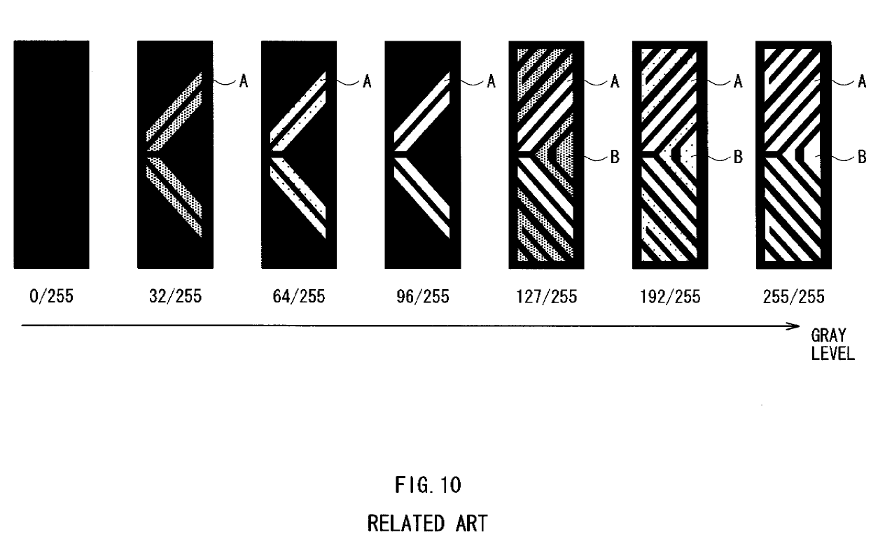

FIGS. 11A, 11B and 11C are illustrations and an equivalent circuit diagram showing configurations of a pixel electrode in each sub pixel shown in FIG. 10 and a common electrode;

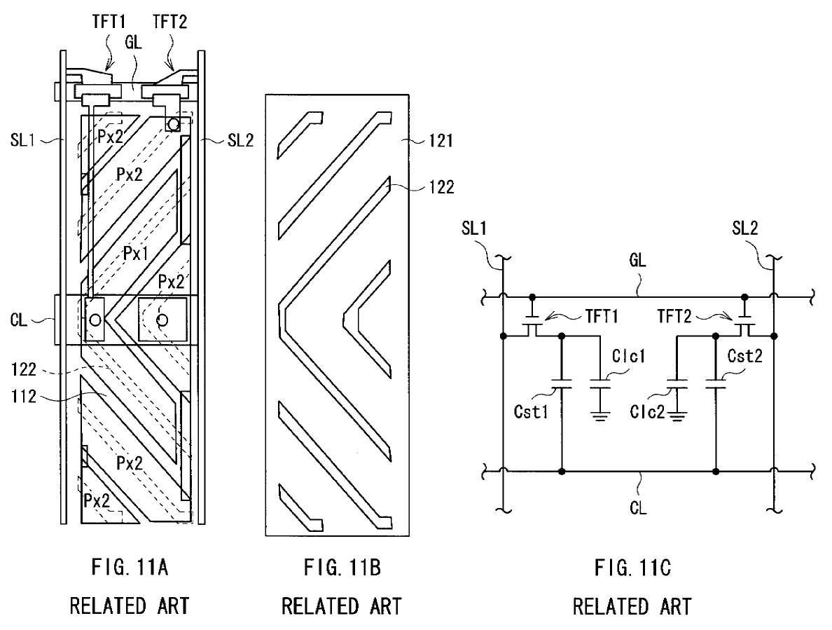

FIGS. 12A and 12B are illustrations for describing the width of a slit shown in FIGS. 11A, 11B and 11C;

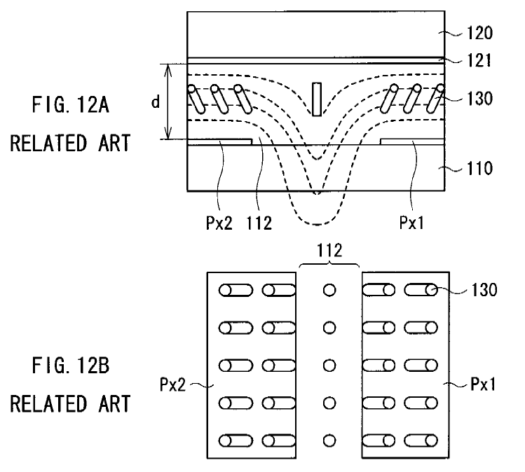

FIGS. 13A and 13B are illustrations for describing the width of the slit shown in FIGS. 11A, 11B and 11C;

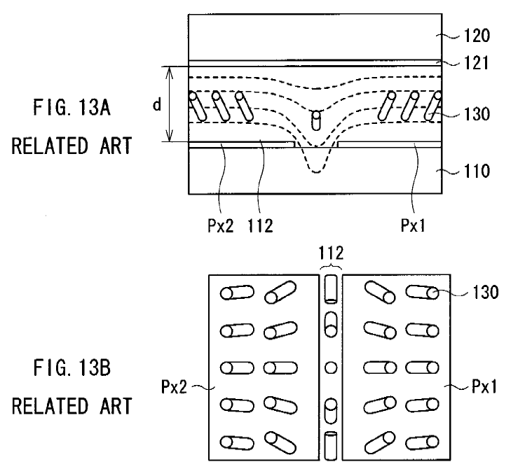

FIG. 14 is an illustration showing a relationship between the width of the slit and transmittance;

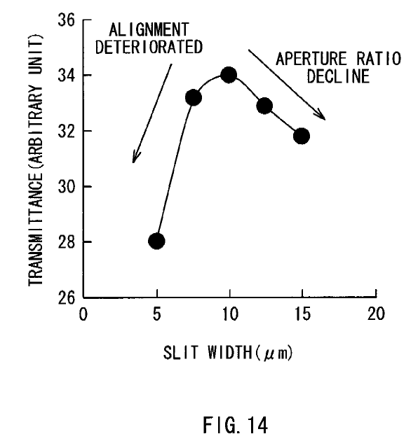

FIG. 15 is an illustration for describing the alignment of liquid crystal molecules in the slit in the case where a voltage having a reverse polarity is applied to two pixel electrodes shown in FIGS. 11A, 11B and 11C;

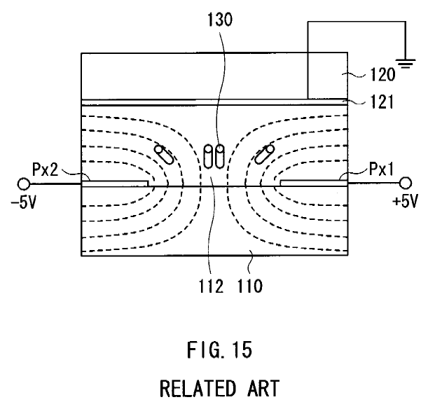

FIGS. 16A and 16B are plan views showing the configuration of a pixel in reverse polarity driving;

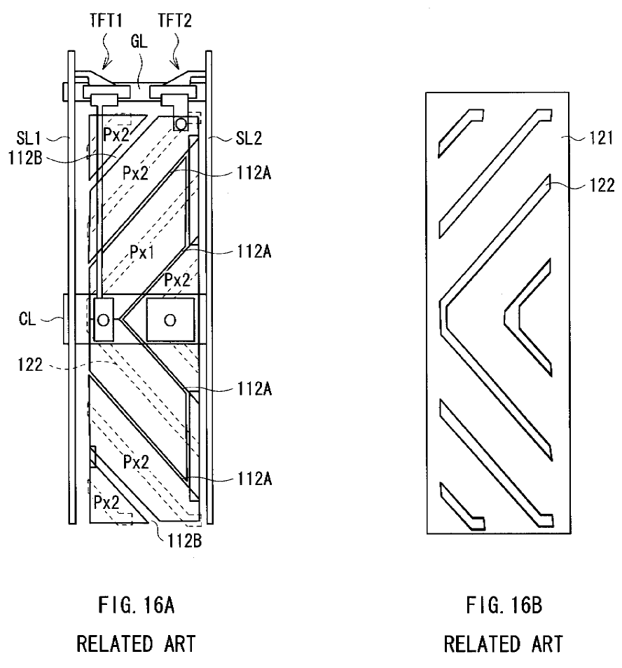

FIG. 17 is an illustration showing transmittance in the case where the width of the slit is reduced; and

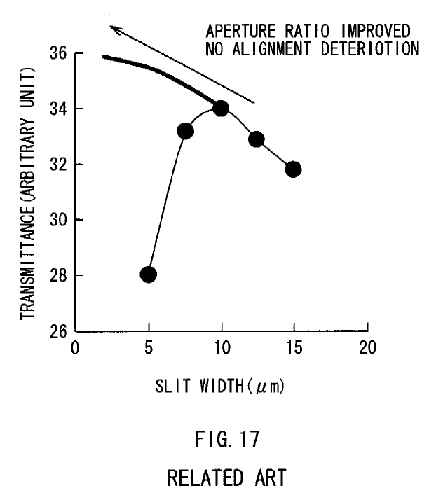

FIGS. 18A and 18B are a plan view and an equivalent circuit diagram for describing an issue in narrowing a slit in a related art.

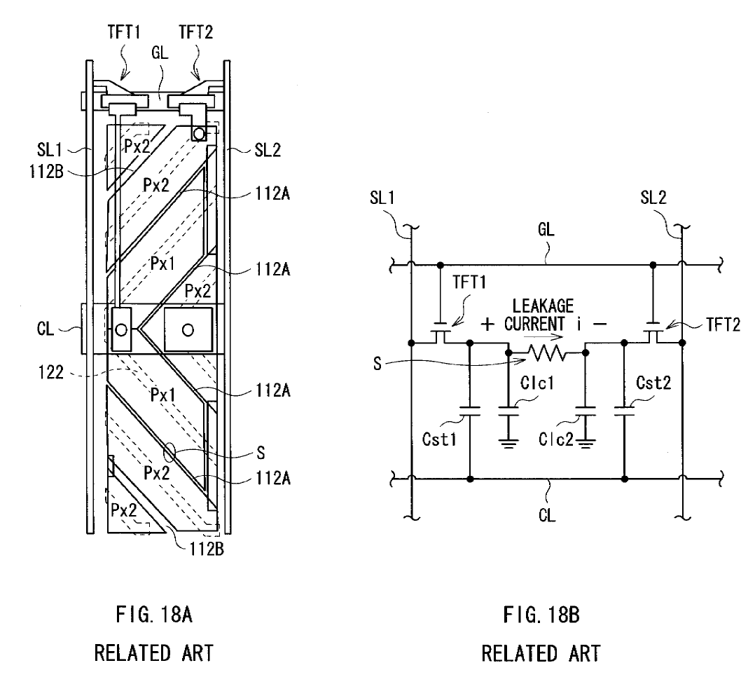

### DETAILED DESCRIPTION OF THE PREFERRED EMBODIMENTS

Preferred embodiments will be described in detail below referring to the accompanying drawings.

### First Embodiment

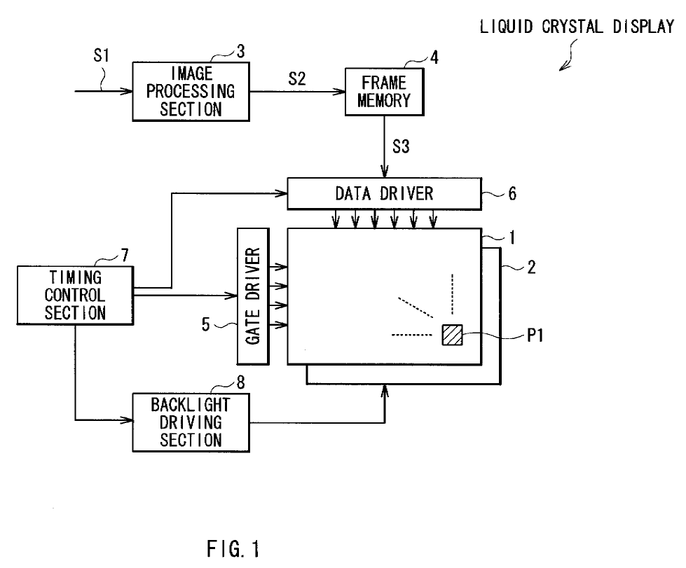

FIG. 1 shows the configuration of a liquid crystal display according to a first embodiment of the invention. The liquid crystal display is a VA mode liquid crystal display used for a liquid crystal television or the like, and the liquid crystal display includes, for example, a liquid crystal display panel 1, a backlight section 2, an image processing section 3, a frame memory 4, a gate driver 5, a data driver 6, a timing control section 7 and a backlight driving section 8.

The liquid crystal display panel 1 displays an image on the basis of a video signal Di transmitted from the data driver 6 in response to a driving signal supplied from the gate driver 5, and includes a plurality of pixels P1 arranged in a matrix form, and the liquid crystal display panel 1 is an active matrix liquid crystal display panel in which each pixel P1 is driven. A specific configuration of the pixel P1 will be described later.

The backlight section 2 is a light source applying light to the liquid crystal display panel 1, and includes, for example, a CCFL (Cold Cathode Fluorescent Lamp) an LED (Light Emitting Diode) or the like.

The image processing section 3 performs predetermined image processing on a video signal S1 from outside to produce a video signal S2 which is an RGB signal.

The frame memory 4 stores the video signal S2 supplied from the image processing section 3 for each pixel P in a frame.

The timing control section 7 controls the timing of driving the gate driver 5, the data driver 6 and the backlight driving section 8. Moreover, the backlight driving section 8 controls the illumination operation of the backlight section 2 according to the timing control of the timing control section 7.

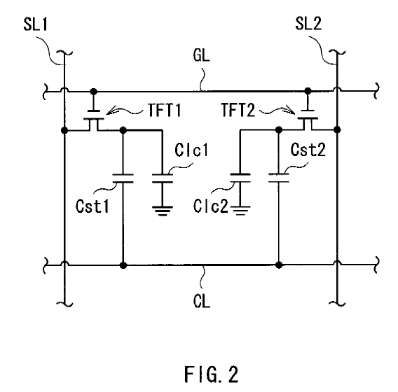

Referring to FIGS. 2 to 4, the specific configuration of each pixel P1 of the liquid crystal display panel 1 will be described below. Each pixel P1 has a multipixel configuration including two subpixels, and displays, for example, any one of primary colors red (R), green (G) and blue (B).

FIG. 2 shows the equivalent circuit of the pixel P1. The pixel P1 includes thin film transistors TFT1 and TFT2, a liquid crystal device Clc1 constituting one subpixel (hereinafter referred to as subpixel A), a liquid crystal device Clc2 constituting another subpixel (hereinafter referred to as subpixel B), and capacitors Cst1 and Cst2.

The thin film transistors TFT1 and TFT2 each have a function as a switching device for supplying a video signal S3 to the subpixels A and B, and are made of, for example, an MOS-FET (Metal Oxide Semiconductor-Field Effect Transistor), and each of the thin film transistors TFT1 and TFT2 includes three electrodes, a gate, a source and a drain. The gates of the thin film transistors TFT1 and TFT2 are connected to a gate bus line GL extending in a horizontal direction. Two source bus lines SL1 and SL2 extending in a vertical direction is orthogonal to the gate bus line GL. The source of the thin film transistor TFT1 is connected to the source bus line SL1, and the drain of the thin film transistor TFT1 is connected to an end of the liquid crystal device Clc1 and an end of the capacitor Cst1. The source of the thin film transistor TFT2 is connected to the source bus line SL2, and the drain of the thin film transistor TFT2 is connected to an end of the liquid crystal device Clc2 and an end of the capacitor Cst2.

The liquid crystal devices Clc1 and Clc2 each have a function as a display device performing an operation for display in response to a signal voltage supplied through the thin film transistors TFT1 and TFT2. The other end of the liquid crystal device Clc1 and the other end of the liquid crystal device Clc2 constitute a common electrode on a substrate surface with a liquid crystal in between.

The capacitors Cst1 and Cst2 generate a potential difference between both ends of the capacitor Cst1 and between both ends of the capacitor Cst2, and more specifically, the capacitors Cst1 and Cst2 each include a dielectric storing an electrical charge. The other end of the capacitor Cst1 and the other end of the capacitor Cst2 are connected to a capacitor bus line CL extending in parallel to the gate bus line GL, that is, in a horizontal direction.

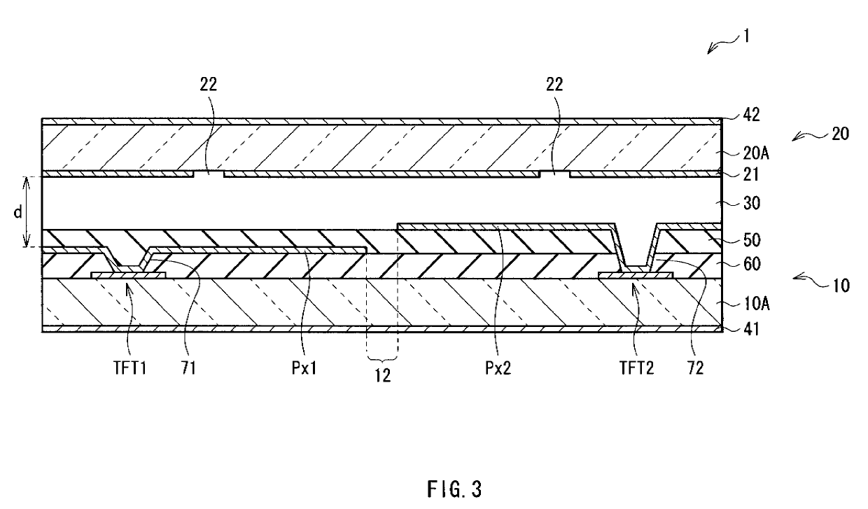

FIG. 3 shows a sectional view of the liquid crystal display panel 1. The liquid crystal display panel 1 includes a VA mode liquid crystal layer 30 between a TFT substrate (drive substrate) 10 and a facing substrate 20. Polarizing plates 41 and 42 are arranged on the TFT substrate 10 and the facing substrate 20, respectively, so that the optical axes (not shown) of the polarizing plates 41 and 42 are orthogonal to each other.

The TFT substrate 10 is formed by forming the thin film transistors TFT1 and TFT2 and the subpixel electrodes Px1 and Px2 in each pixel P1 on the glass substrate 10A. A slit 12 for controlling liquid crystal molecular alignment is arranged between the subpixel electrodes Px1 and Px2. The liquid crystal devices Clc1 and Clc2 and the like shown in FIG. 2 (but not shown in FIG. 3) are arranged on the glass substrate 10A.

The subpixel electrode Px1 constitutes the subpixel A, and the subpixel electrode Px2 constitutes the subpixel B, and the subpixel electrodes Px1 and Px2 are electrically connected to the thin film transistors TFT1 and TFT2, respectively. The subpixel electrodes Px1 and Px2 are made of, for example, ITO (Indium Tin Oxide) which is a solid solution material of tin oxide (SnO₂) and indium oxide (In₂O₃). As shown in an equivalent circuit diagram in FIG. 2, the subpixel electrode Px1 and the subpixel electrode Px2 are electrically independent of each other, and a voltage having a reverse polarity is applied to the subpixel electrodes Px1 and Px2 in the same frame. Thereby, the width of the slit 12 in the pixel P1 is able to be reduced, and the transmittance is able to be improved.

An inter-subpixel insulating layer 50 is formed between the subpixel electrode Px1 and the subpixel electrode Px2. Thereby, in the liquid crystal display, the slit 12 between the subpixel electrodes Px1 and Px2 is able to be narrowed, and a short circuit defect is able to be prevented.

More specifically, the thin film transistors TFT1 and TFT2 are covered with an interlayer insulating layer 60, and the subpixel electrode Px1 is formed on the interlayer insulating layer 60, and the inter-subpixel insulating layer 50 is formed on the subpixel electrode Px1 and the interlayer insulating layer 60, and the subpixel electrode Px2 is formed on the inter-subpixel insulating layer 50. The subpixel electrode Px1 is electrically connected to the thin film transistor TFT1 through a first connecting hole 71 arranged in the interlayer insulating layer 60, and the subpixel electrode Px2 is electrically connected to the thin film transistor TFT2 through a second connecting hole 72 arranged in the inter-subpixel insulating layer 50 and the interlayer insulating layer 60.

The area of the subpixel electrode Px2 is preferably larger than the area of the subpixel electrode Px1. It is because in the subpixel electrode Px1 in a lower position, a voltage applied to the liquid crystal layer 30 with respect to an applied voltage is decayed by the thickness of the inter-subpixel insulating layer 50, so when a subpixel electrode with a larger area is arranged on a higher position, a decline in intensity is reduced.

The facing substrate 20 is formed by forming a common electrode 21 made of ITO on a glass substrate 20A. A color filter and a black matrix or the like (both not shown) are formed on the glass substrate 20A. In the common electrode 21, a slit 22 for controlling the liquid crystal molecular alignment is arranged in a position where the slit 22 does not overlap the slit 12 of the pixel electrode 11.

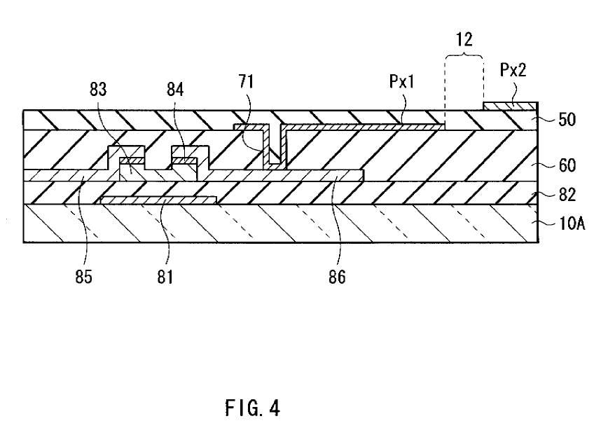

FIG. 4 shows an example of a connection configuration of the thin film transistor TFT1 and the subpixel electrode Px1. The thin film transistor TFT1 is formed by laminating, for example, a gate electrode 81, a gate insulating film 82, an amorphous silicon layer 83, an n+amorphous silicon layer 84, and a source electrode 85 and a drain electrode 86 on the glass substrate 10A in this order, and the subpixel electrode Px1 is connected to the drain electrode 86 of the thin film transistor TFT1 through the first connecting hole 71.

The liquid crystal display is able to be manufactured by the following manufacturing method, for example.

At first, for example, the thin film transistors TFT1 and TFT2 are formed on the glass substrate 10A by a typical manufacturing method. Next, the interlayer insulating layer 60 with which the thin film transistors TFT1 and TFT2 are covered is formed, and the first connecting hole 71 is formed by patterning. Next, the subpixel electrode Px1 is formed, and is patterned into a predetermined shape. After that, the inter-subpixel insulating layer 50 is formed on the subpixel electrode Px1 and the interlayer insulating layer 60, and the second connecting hole 72 is formed by patterning. Next, the subpixel electrode Px2 is formed on the inter-subpixel insulating layer 50, and is patterned into a predetermined shape. Thereby, the drive substrate 10 is formed.

Moreover, the common electrode 21 having the slit 22 is formed on the glass substrate 20A by a typical manufacturing method to form the facing substrate 20.

After the drive substrate 10 and the facing substrate 20 are formed, the drive substrate 10 and the facing substrate 20 are arranged so as to face each other, and a sealing layer (not shown) is formed around them, and a liquid crystal is injected into the inside of the sealing layer to form the liquid crystal layer 30. Thereby, the liquid crystal display panel 1 shown in FIGS. 2 to 4 is formed. The liquid crystal display panel 1 is incorporated in a system including the backlight section 2, the image processing section 3, the frame memory 4, the gate driver 5, the data driver 6, the timing control section 7 and the backlight driving section 8 to complete the liquid crystal display according to the embodiment.

In the liquid crystal display panel 1, as shown in FIG. 1, the image processing section 3 performs image processing on the video signal S1 supplied from outside so as to produce the video signal S2 for each pixel P1. The video signal S2 is stored in the frame memory 4, and the video signal S2 is supplied to the data driver 6 as the video signal S3. On the basis of the video signal S3 supplied in such a manner, line-sequential display driving operation is performed in each pixel P1 by a driving voltage outputted from the gate driver 5 and the data driver 6 to each pixel P1. More specifically, the thin film transistors TFT1 and TFT2 turn on and off in response to a selection signal supplied from the gate driver 5 through the gate bus line GL so that the source bus line SL and the pixel P1 are selectively brought into conduction. Thereby, illumination light from the backlight section 2 is modulated by the liquid crystal display panel 1 to be outputted as display light.

In this case, the inter-subpixel insulating layer 50 is arranged between the subpixel electrode Px1 and the subpixel electrode Px2, so even if a planar defect is present between the subpixel electrode Px1 and the subpixel electrode Px2, the occurrence of a short circuit is prevented. Thereby, the subpixel electrode Px1 and the subpixel electrode Px2 are able to be placed close to the limit. Therefore, the slit 12 between the subpixel electrode Px1 and the subpixel electrode Px2 is able to be narrowed, and the transmittance is improved by the stability of the liquid crystal molecular alignment.

Thus, in the embodiment, the inter-subpixel insulating layer 50 is arranged between the subpixel electrode Px1 and the subpixel electrode Px2, so the slit 12 between the subpixel electrode Px1 and the subpixel electrode Px2 is able to be narrowed, and a short circuit defect is able to be prevented. Therefore, an advantage of narrowing a slit which is that the liquid crystal molecular alignment is stabilized to improve the transmittance is able to be further utilized.

### Second Embodiment

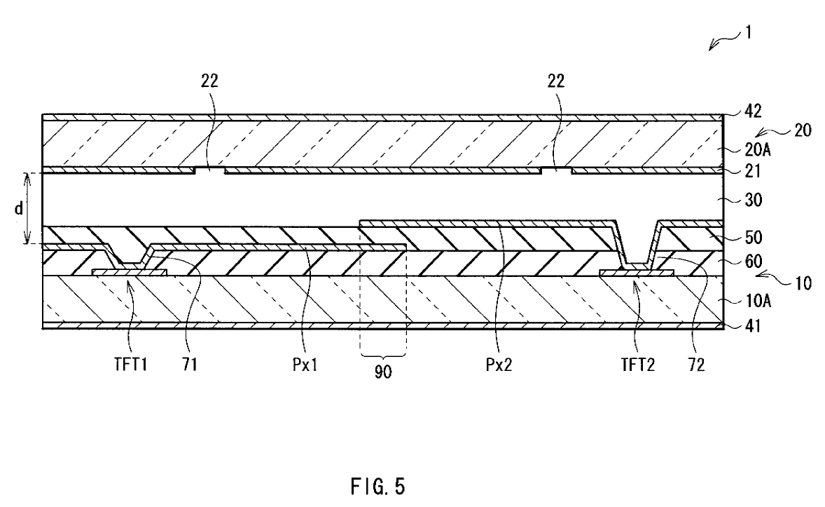

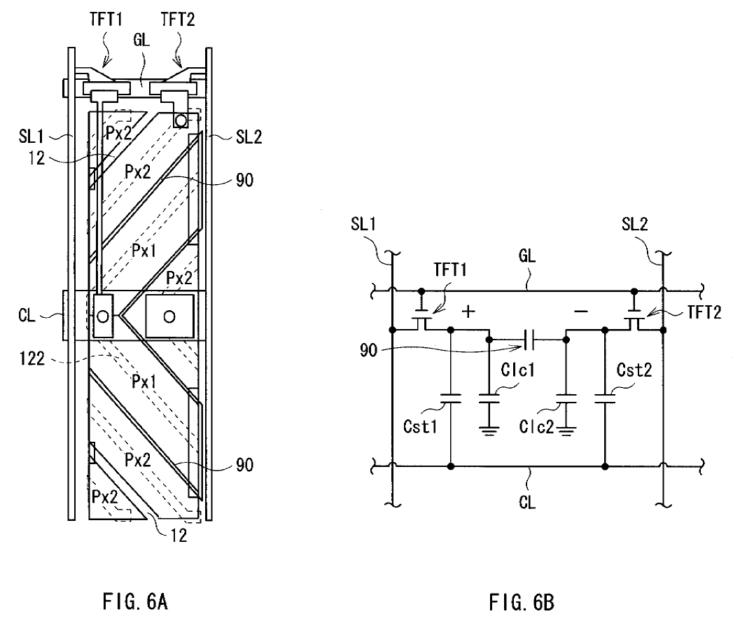

FIG. 5 shows a sectional view of the liquid crystal display panel 1 according to a second embodiment of the invention, and FIG. 6A is a plan view of the liquid crystal display panel 1, and FIG. 6B shows an equivalent circuit diagram of the liquid crystal display panel 1. In the liquid crystal panel 1, an end of the subpixel electrode Px1 and an end of the subpixel electrode Px2 overlap each other with the inter-subpixel insulating layer 50 in between to form a laminate section 90. Except for this, the embodiment has the same configuration, functions and effects of the first embodiment, and the same manufacturing method as that in the first embodiment is applicable to the embodiment. Therefore, like components are denoted by like numerals.

In the laminate section 90, the subpixel electrodes Px1 and Px2 overlap each other; however, the inter-subpixel insulating layer 50 is arranged between them, so a short circuit does not occur. Moreover, the substantial slit width is approximately 0, so the advantage of narrowing a slit which is that the liquid crystal molecular alignment is stabilized to improve the transmittance is able to be maximized.

Further, as shown in the equivalent circuit in FIG. 6B, in the laminate section 90, a new capacity is formed between the subpixel electrodes Px1 and Px2, so an effect of increasing a pixel capacity is obtained.

### Third Embodiment

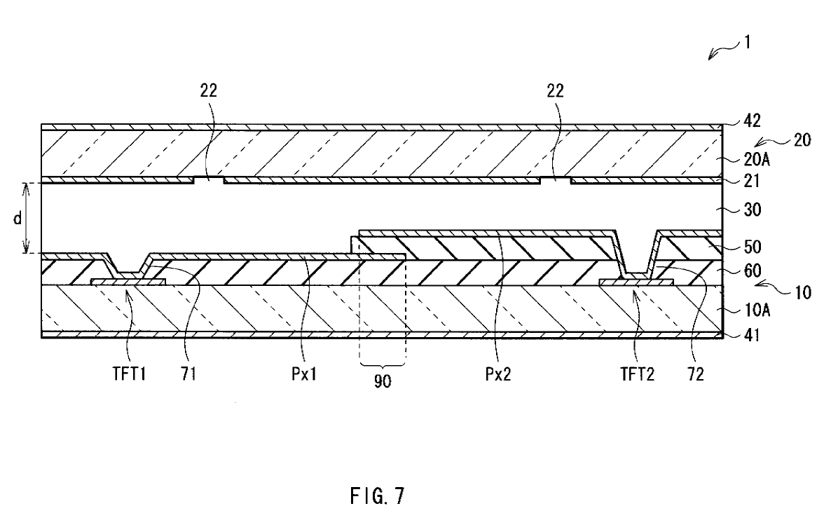

FIG. 7 shows a sectional view of the liquid crystal display panel 1 according to a third embodiment of the invention. In the liquid crystal panel 1, the inter-subpixel insulating layer 50 is formed between the subpixel electrode Px2 and the interlayer insulating layer 60, and the inter-subpixel insulating layer 50 is removed in a region not overlapping an end of the subpixel electrode Px2 of the subpixel electrode Px1. Except for this, the embodiment has the same configurations, functions and effects as those in the second embodiment. Therefore, like components are denoted by like numerals.

In the region not overlapping an end of the subpixel electrode Px2 of the subpixel electrode Px1, the inter-subpixel insulating layer 50 is removed, thereby the voltage of the subpixel electrode Px1 is applied to the liquid crystal layer 30 without decay, so a decline in intensity is able to be prevented. Moreover, the inter-subpixel insulating layer 50 is formed between the subpixel electrode Px2 and the interlayer insulating layer 60, so a short circuit between the subpixel electrodes Px1 and Px2 is able to be prevented.

The liquid crystal display is able to be manufactured by the same manufacturing method as that in the first embodiment, except that when the inter-subpixel insulating layer 50 is patterned to form the second connecting hole 72, the inter-subpixel insulating layer 50 is removed in the region not overlapping an end of the subpixel electrode Px2 of the subpixel electrode Px1.

The embodiment is applicable to the case where ends of the subpixel electrodes Px1 and Px2 do not overlap each other as in the case of the first embodiment.

### Fourth Embodiment

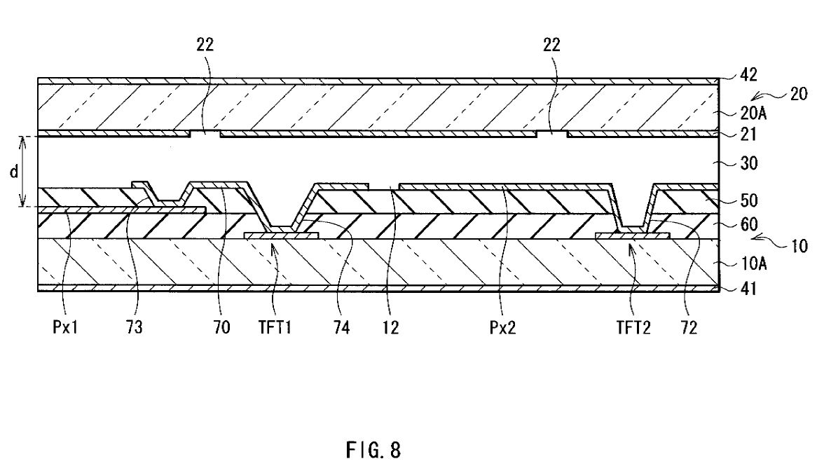

FIG. 8 shows a sectional view of the liquid crystal display panel 1 according to a fourth embodiment of the invention. In the liquid crystal panel 1, a connecting section 70 electrically connecting the subpixel electrode Px1 and the thin film transistor TFT1 to each other is arranged, so pattering of the interlayer insulating layer 60 is not necessary, thereby manufacturing steps are able to be simplified. Except for this, the embodiment has the same configuration, functions and effects as those in the second embodiment. Therefore, like components are denoted by like numerals.

The connecting section 70 is electrically connected to the subpixel electrode Px1 through a third connecting hole 73 arranged in the inter-subpixel insulating layer 50, and is electrically connected to the thin film transistor TFT1 through a fourth connecting hole 74 arranged in the inter-subpixel insulating layer 50 and the interlayer insulating layer 60. The slit 12 is arranged between the connecting section 70 and the subpixel electrode Px2.

Moreover, the connecting section 70 may be arranged in a part where the subpixel electrode Px1 and the thin film transistor TFT1 are connected to each other, and in a part other than the part, the subpixel electrodes Px1 and Px2 may have the same configurations as those in the first, second and third embodiments.

The liquid crystal display is able to be manufactured by the following manufacturing method, for example.

At first, the thin film transistors TFT1 and TFT2 are formed on the glass substrate 10A by a typical manufacturing method. Next, the interlayer insulating layer 60 with which the thin film transistors TFT1 and TFT2 are covered is formed. Then, the subpixel electrode Px1 is formed, and is patterned into a predetermined shape. After that, the inter-subpixel insulating layer 50 is formed on the subpixel electrode Px1 and the interlayer insulating layer 60, and the third connecting hole 73 and the fourth connecting hole 74 are formed by patterning. After the inter-subpixel insulating layer 50 is patterned, the subpixel electrode Px2 and the connecting section 70 are formed on the inter-subpixel insulating layer 50, and are patterned into a predetermined shape. Thereby, the drive substrate 10 is formed.

Moreover, as in the case of the first embodiment, the facing substrate 20 is formed, and the drive substrate 10 and the facing substrate 20 are arranged so as to face each other, and a sealing layer (not shown) is formed around them, and a liquid crystal is injected into the inside of the sealing layer so as to form the liquid crystal layer 30, thereby the liquid crystal display panel 1 is formed. The liquid crystal display panel 1 is incorporated into a system including the backlight section 2, the image processing section 3, the frame memory 4, the gate driver 5, the data driver 6, the timing control section 7 and the backlight driving section 8 to form the liquid crystal display according to the embodiment.

### Fifth Embodiment

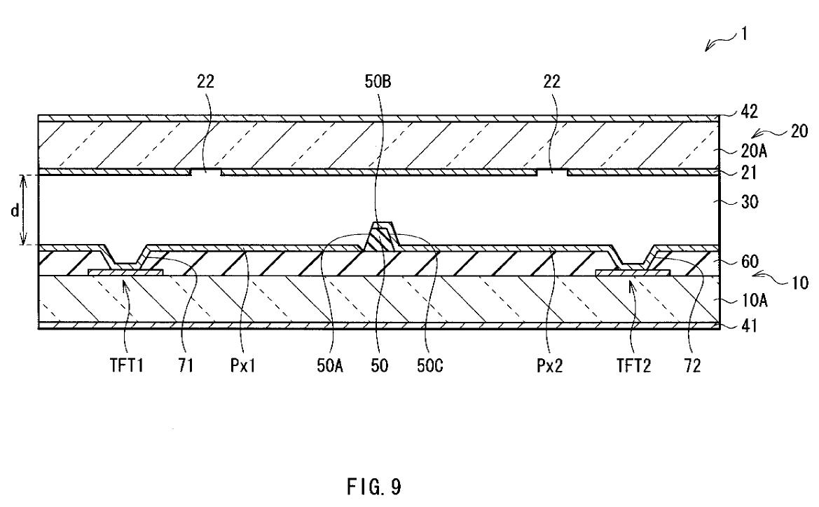

FIG. 9 shows a sectional view of the liquid crystal display panel 1 according to a fifth embodiment of the invention. In the liquid crystal panel 1, the inter-subpixel insulating layer 50 is a linear projection, and the subpixel electrode Px1 is formed on the interlayer insulating layer 60 on a side closer to one side surface 50A of the inter-subpixel insulating layer 50, and the subpixel electrode Px2 is formed on a top surface 50B and the other side surface 50C of the inter-subpixel insulating layer S0 and the interlayer insulating layer 60, thereby patterning of the interlayer insulating layer 60 is not necessary, and manufacturing steps are able to be simplified. Except for this, the fifth embodiment has the same configuration, functions and effects as those in the first embodiment. Therefore, like components are denoted by like numerals.

As will be described later, the subpixel electrode Px1 and the subpixel electrode Px2 are formed by oblique evaporation from a side closer to the other side surface 50C of the inter-subpixel insulating layer 60.

The liquid crystal display is able to be manufactured by the following manufacturing method, for example.

At first, for example, the thin film transistors TFT1 and TFT2 are formed on the glass substrate 10A by a typical manufacturing method. Next, the interlayer insulating layer 60 with which the thin film transistors TFT1 and TFT2 are covered is formed. Then, the subpixel electrode Px1 is formed, and is patterned into a predetermined shape. After that, the inter-subpixel insulating layer S0 is formed on the subpixel electrode Px1 and the interlayer insulating layer 60, and is patterned into a linear projection shape. After the inter-subpixel insulating layer S0 is patterned, by oblique evaporation from a side closer to the other side surface 50C of the inter-subpixel insulating layer 50, the subpixel electrode Px2 is formed on the top surface 50B and the other side surface 50C of the inter-subpixel insulating layer 50 and the interlayer insulating layer 60, and the subpixel electrode Px1 is formed on the interlayer insulating layer 60 on a side closer to one side surface 50A of the inter-subpixel insulating layer 50. Thereby, the drive substrate 10 is formed.

Moreover, as in the case of the first embodiment, the facing substrate 20 is formed, and the drive substrate 10 and the facing substrate 20 are arranged so as to face each other, and a sealing layer (not shown) is formed around them, and a liquid crystal is injected into the inside of the sealing layer to form the liquid crystal layer 30, thereby the liquid crystal display panel 1 is formed. The liquid crystal display panel 1 is incorporated into a system including the backlight section 2, the image processing section 3, the frame memory 4, the gate driver 5, the data driver 6, the timing control section 7 and the backlight driving section 8 to complete the liquid crystal display according to the embodiment.

Although the present invention is described referring to the embodiments, the invention is not limited to the above-described embodiments, and may be variously modified. For example, in the above-described embodiments, an example in which each pixel is divided into two subpixels is described; however, the invention is applicable to the case where each pixel is divided into three or more subpixels.

Moreover, the shape of the subpixel is not limited to the shapes in the above-described embodiments, and the subpixel may have any other shape, for example, a square shape or a rectangular shape, and the subpixel may have a configuration in which the plane area of the pixel is substantially divided.

In addition, in the above-described embodiments, the case where the thin film transistors TFT1 and TFT2 are used as non-linear elements is described as an example; however, the non-linear element may be a TFD (Thin Film Diode).

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display comprising a plurality of pixels arranged in a matrix form,
wherein each of the pixels includes:
a plurality of non-linear elements formed on a substrate;
a plurality of subpixel electrodes electrically connected to the plurality of non-linear elements, respectively; and
an inter-subpixel insulating layer formed between at least two subpixel electrodes out of the plurality of subpixel electrodes.

2. The liquid crystal display according to claim 1, wherein
the area of one of the two subpixel electrodes is larger than the area of the other subpixel electrode.

3. The liquid crystal display according to claim 1, wherein
ends of the two subpixel electrodes overlap each other with the inter-subpixel insulating layer in between.

4. The liquid crystal display according to claim 1, comprising:
an interlayer insulating layer with which the plurality of non-linear elements are covered,
wherein a first subpixel electrode of the two subpixel electrodes is formed on the interlayer insulating layer,
the inter-subpixel insulating layer is formed on the first subpixel electrode and the interlayer insulating layer, and
a second subpixel electrode of the two subpixel electrodes is formed on the inter-subpixel insulating layer.

5. The liquid crystal display according to claim 4, wherein
the first subpixel electrode is electrically connected to a first non-linear element of the plurality of non-linear elements through a first connecting hole arranged in the interlayer insulating layer, and
the second subpixel electrode is electrically connected to a second non-linear element of the plurality of non-linear elements through a second connecting hole arranged in the inter-subpixel insulating layer and the interlayer insulating layer.

6. The liquid crystal display according to claim 4, wherein
the inter-subpixel insulating layer is formed between the second subpixel electrode and the interlayer insulating layer, and is removed in a region not overlapping an end of the second subpixel electrode of the first subpixel electrode.

7. The liquid crystal display according to claim 4, comprising:
a connection section electrically connecting the first subpixel electrode and a first non-linear element of the plurality of non-linear elements to each other,
wherein the connection section is electrically connected to the first subpixel electrode through a third connecting hole arranged in the inter-subpixel insulating layer, and is electrically connected to the first non-linear element through a fourth connecting hole arranged in the inter-subpixel insulating layer and the interlayer insulating layer.

8. The liquid crystal display according to claim 1, wherein
the inter-subpixel insulating layer is a linear projection,
a first subpixel electrode of the two subpixel electrodes is formed on the interlayer insulating layer on a side closer to one side surface of the inter-subpixel insulating layer, and
a second subpixel electrode of the two subpixel electrodes is formed on the top surface and the other side surface of the inter-subpixel insulating layer and the interlayer insulating layer.

9. The liquid crystal display according to claim 8, wherein
the first subpixel electrode and the second subpixel electrode are formed by oblique evaporation from a side closer to the other side surface of the inter-subpixel insulating layer.
